(19) United States
(12) Patent Application Publication
(10) Pub. No.: US 2006/0080591 A1
(43) Pub. Date: Apr. 13, 2006

(54) Apparatus and method for automated temporal compression of multimedia content

(76) Inventors: Ho Chao Huang, Shindian City (TW); Wen Chin Tseng, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/963,052

(22) Filed: Oct. 12, 2004

(51) Int. Cl. G06F 17/21; G06F 17/00

(52) U.S. Cl. 715/500.1; 715/730

(57) ABSTRACT

A apparatus and method for automated temporal compression of content is disclosed. The apparatus includes a processor and a temporal compression module. The processor implements the temporal compression module to provide a given work of multimedia content at a plurality of playback rates.

### TECHNICAL FIELD

The present invention is generally related to an apparatus and method for automated temporal compression and, more particularly, is related to an apparatus and method for temporal compression based upon a playback duration.

### BACKGROUND OF THE INVENTION

Today, many people possess the capability and equipment to create and/or record and view multimedia content. For example, a person can create their own works of multimedia content using a common video camera, or download works of multimedia content from the internet, or record works of multimedia content provided by a television system. Each work of multimedia content has a natural playback duration (length), which is defined as the time span that is required to play the work of multimedia content in its entirety at its natural (normal) playback rate.

Sometimes, a person wants to play a given work of multimedia content within a desired playback duration (T_{D}) which is shorter than the natural playback duration of the given work. The user may use a multimedia content player that plays given work at a playback rate that is different than the natural playback rate. A problem with many current multimedia content players is that they play the entire work of multimedia content at the natural playback rate, which is the rate at which it was recorded.

Sometimes a user might load a work of multimedia content into a computer so that the work can be edited. Among other things, the user might want to edit the work such that the playback duration of the work approximately matches a desired playback duration. Using present systems, it is a time consuming process for the user to manually select portions of the work of multimedia content to cut/drop such that the playback duration of the edited work matches the desired playback duration.

Thus, a heretofore unaddressed need exists in the industry to address the aforementioned deficiencies and inadequacies.

### SUMMARY OF THE INVENTION

Embodiments of the present invention provide an apparatus and method for automated editing of content to permit playback of a recorded work of multimedia content over a selectable duration period. Briefly described, in architecture, one embodiment of the apparatus, among others, can be implemented as follows. The apparatus includes a processor and a temporal compression module. The processor implements the temporal compression module to provide a given work of multimedia content at a plurality of playback rates.

Embodiments of the present invention can also be viewed as providing methods for automated editing of content. In this regard, one embodiment of such a method, among others, includes the steps of receiving user input and categorizing segments of a work of multimedia content based at least in part upon information carried by the multimedia content. Finally, the method also includes the step of determining playback rates for the segments of the multimedia content.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a diagram of one embodiment of an automated temporal compression system.

FIG. 2 a diagram of a second embodiment of an automated temporal compression system.

FIG. 3 is a block diagram of an automated temporal compression system.

FIG. 4 is a block diagram of memory of the automated temporal compression system.

FIG. 5A illustrates the playback duration of a given work of multimedia content.

FIG. 5B illustrates the playback duration of the temporally compressed given work.

FIG. 6 is depicts a method of providing a work of multimedia content.

FIG. 7A and FIG. 7B depict a method of temporally compressing a work of multimedia content.

FIG. 8 depicts a method of categorizing segments of a work of multimedia content.

### DETAILED DESCRIPTION OF THE PREFERRED EMBODIMENT

In accordance with embodiments of the invention, a user of an automated temporal compression system will provide a recorded work of multimedia content to the automated temporal compression system. The user also provides a desired playback duration for the recorded work to the automated temporal compression system. Using the desired playback duration specified by the user and by analyzing the content of the recorded work, the automated temporal compression system plays the recorded work back over a time span that is approximately equal to the desired playback duration. For example, a work that takes two hours to record will have a natural playback duration of two hours, but the automated temporal compression system will play the recorded work in 1 hour, or 1.5 hours, or any other desired playback duration selected by the user. The automated temporal compression system compresses the playback duration by selectively dropping content, i.e., cutting content from the work, and/or by selectively playing segments at faster than normal play rates. Although embodiments of the present invention are described in terms of temporal compression, it should be realized by those skilled in the art that the present invention can also be used to temporally stretch a work. In other words, if the desired playback duration is greater than the natural playback duration, then the system can selectively play segments of the work at a slower playback rate such that the actual playback duration approximately matches the desired playback duration.

Normally, both recorded and live works of multimedia digital content are played at a constant rate of frames, ν₀ where ν₀ is equal to the number of frames played per second at normal/natural playback speed. For the purposes of this disclosure ν₀ is defined as the natural play rate. Consequently, the natural play time (T₀) for a work of multimedia digital content having N₀ frames is simply the number of frames (N₀) divided by the natural play rate, T₀=(N₀/ν₀). When a user wants to play a work of multimedia digital content in a time span that is shorter than T₀, the user implements an automated time compression system (ATCS) and inputs a desired playing duration (T_{D}). The ATCS then plays the work of multimedia digital content at variable play rates, i.e., some frames are played at a play rate of ν₁ and other frames are played at a play rate of ν₂, etc. Typically, there are more than two play rates, and sometimes, selected frames of the work of multimedia digital content are dropped and not played at all. Exemplary methods by which the automated time compression system determines play rates and which frames, if any, to dropped are described in detail hereinbelow.

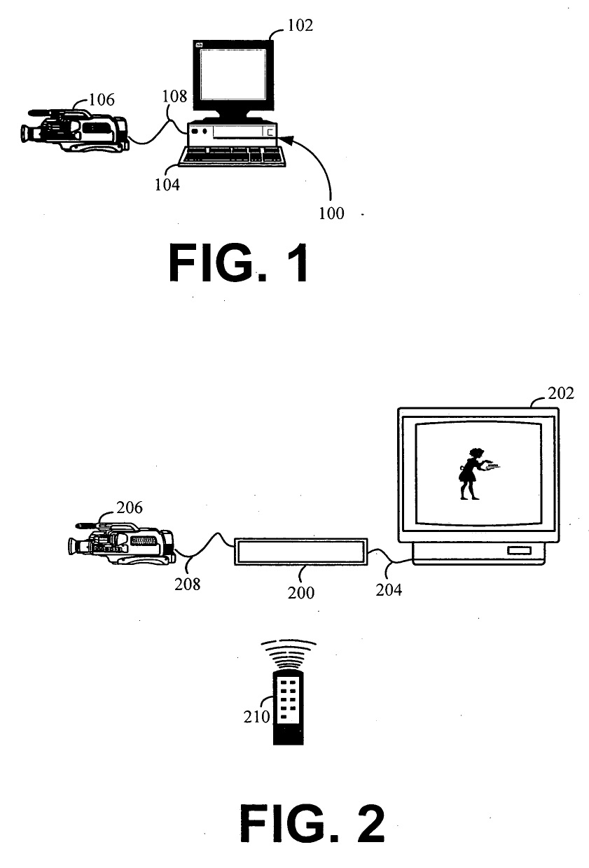

FIGS. 1 and 2 depict an overview of two embodiments of an automated temporal compression system (ATCS) 10(A) and 10(B), respectively. Embodiments are described in terms of temporally compressing digital multimedia content including video content that conforms to a Motion Pictures Expert Group (MPEG) protocols such as MPEG-1 and MPEG-2, but this is done only for the sake of clarity and is a non-limiting example. The ATCSs 10(A) and 10(B) are intended to temporally compress multimedia digital content regardless of the format of the multimedia digital content.

FIG. 1 depicts ATCS 10(A), which includes a computer system 100 having the necessary logic for temporally compressing multimedia digital content. The computer system 100 includes a monitor 102, a keyboard 104 and a mouse (not shown). The user of the computer system 100 uses the keyboard and/or mouse and/or other input devices to provide user input such as the desired play duration (T_{D}). The computer system 100 is a standard personal computer having an internal storage device (not shown) such as a hard drive and is usually adapted to couple to an external storage device (not shown) and/or external input devices (not shown).

A video camera 106 is coupled to the computer system 100 via an electrical cable 108. The video camera 106 may for example, be a digital camcorder, which records multimedia content in a variety of digital formats. In this embodiment, electrical cable 108 may be any number of common computer interface cables, such as, but not limited to IEEE-1394 High Performance Serial Bus (Firewire), Universal Serial Bus (USB), a serial connection, or a parallel connection. Multimedia digital content is downloaded from the video camera 106 and stored in a mass storage device of the computer system 100. A user of the computer system 100 can then view the stored video content on the monitor 102.

FIG. 2 depicts broader aspects of ATCS 10(B). The ATCS 10(B) includes a digital player 200 coupled to a TV 202 via an electrical connector 204. The digital player 200 is adapted to receive content from a digital camera 206 via a second electrical connector 208 and provide multimedia digital content to the TV 202. The user of the ATCS 100(B) uses a remote control 210 to provide user input to the system.

Although ATCSs 10(A) and 10(B)have been depicted as adapted to receive content from a camera 106 and a camera 206, respectively, it should be understood that these are non-limiting examples. In other preferred embodiments, the computer system 100 and digital player 200 are adapted to receive content from a wide variety of media including, but not limited to, set-top boxes for a subscriber television system, DVD players, and via the Internet.

In addition, the ATCSs 10(A) and/or 10(B) may also form a node on a network (not shown) such as, but not limited to a LAN or a WAN. In this configuration, multimedia bitstreams may be delivered from a remote server (not shown) over a network to the ATCS 10. The connection between the remote server and ATCS 10 may be any number of standard networking interfaces such as a CAT-5, Firewire, or wireless connection. A network interface comprises various components used to transmit and/or receive data over networks. By way of example, a network interface device may include a device that can communicate with both inputs and outputs, for instance, a modulator/demodulator (e.g., a modem), wireless (e.g., radio frequency (RF)) transceiver, a telephonic interface, a bridge, a router, network card, etc.). Furthermore, ATCS 10(A) and/or 10(B) may also include an optical drive (not shown) to receive and read an optical disk (not shown), which may have multimedia bitstreams encoded thereon.

In some embodiments, a multimedia bitstream may be downloaded to the ATCS 10(A) and/or 10(B) using a multimedia input device (not shown) which may be a break-out box, or could be integrated onto an expansion card, either of which are electrically connected to the respective ATCS. The multimedia input device may include a variety of standard digital or analog input connections for receiving multimedia signals such as, but not limited to, RCA jacks, a microphone jack, Sony/Philips Digital Interface (S/PDIF) connections, optical connections, coaxial cable, and S-video connections. The multimedia input device may include an analog-to-digital converter for converting analog multimedia to digital multimedia streams. In an embodiment in which a multimedia input device is a break-out box external to the ATCS 10, the box is electrically connected in an number of ways, for example, but not limited to, Firewire, USB, a serial connection, or a parallel connection.

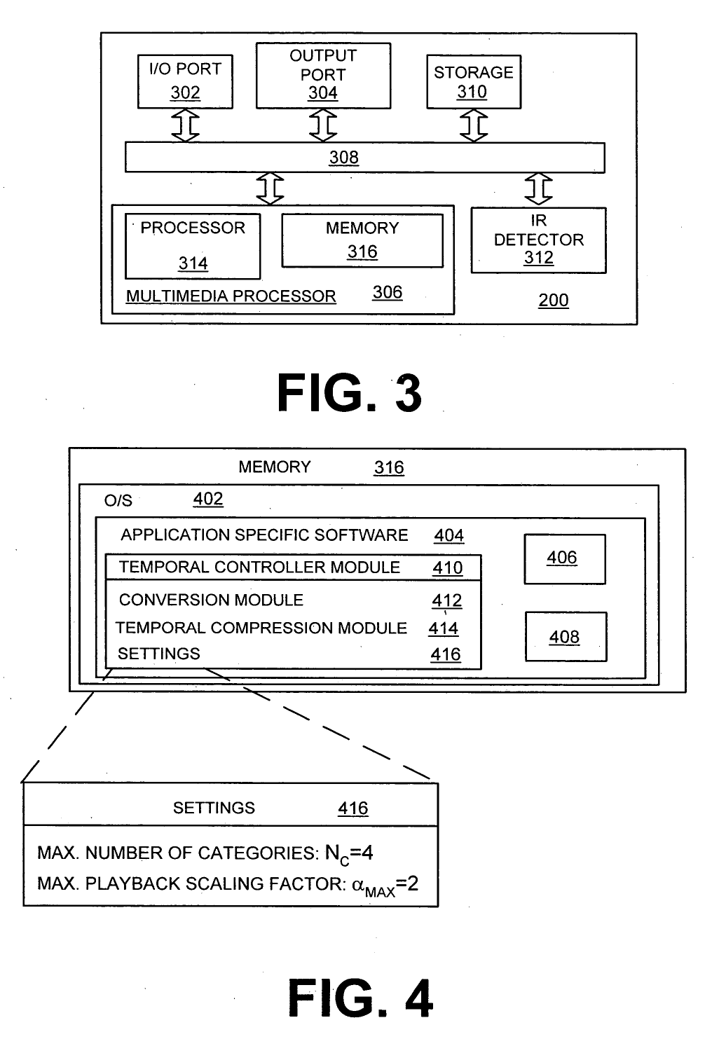

Referring to FIG. 3, the digital player 200 includes an input/output port 302 and an input/output port 304, which are adapted to couple with electrical cables 204 and 208, respectively. Multimedia content can be received through the I/O port 302 and provided to a multimedia processor 306 via a bus 308. The I/O port 302 may include a plurality of interfaces such that it can receive (and provide) content from (and to) a plurality of devices in a plurality of formats. The digital player 200 also includes an infrared detector 312. The infrared detector 312 receives signals generated by the remote control 210, and relays the signals to the multimedia processor 306.

A storage device 310 is in communication with the multimedia processor 306 via the bus 308. The storage device 310 is adapted to store received content so that the content can be replayed at a later time. In one preferred embodiment, multimedia digital content stored in storage device 310 is played back at variable play rates, which are controlled by the multimedia processor 306. The content is provided to the port 304 via the multimedia processor 306 which, if necessary, reformats the multimedia digital content for play on a device such as the TV 202. Many modem TV's are adapted to receive and play multimedia digital content, so in some situations, reformatting content for display on the TV 202 will not be necessary.

The multimedia processor 306 includes a processor 314 and a memory 316. Among other things, the processor 314 implements user commands and modules stored in the memory 316. The memory 316 can include any one of a combination of volatile memory elements (e.g., random-access memory (RAM, such as DRAM, and SRAM, etc.)) and nonvolatile memory elements (e.g., ROM, hard drive, tape, CDROM, etc.).

The multimedia processor 306 is adapted to receive content and then reformat, if necessary, the content to a desired format such as, but not limited to, motion pictures expert group (MPEG), Advanced Visual Interface (AVI), Windows Media Video (WMV), Digital Versatile Disc (DVD), Versatile Compact Disc (VCD), and others known to those skilled in the art. Among other reasons, the multimedia processor 306 reformats content so that the content is in appropriate format for display on the TV 202 and so that the content is physically compressed on the mass storage device 310.

Generally speaking, the ATCS 10(A) and 10(B) can comprise any one of a wide variety of wired and/or wireless computing devices, such as a desktop computer, portable computer, dedicated server computer, multiprocessor computing device, cellular telephone, personal digital assistant (PDA), handheld or pen based computer, embedded appliance and so forth. Irrespective of its specific arrangement, computer system 100 can, for instance, comprise memory, a processing device, a number of input/output interfaces, a network interface device, and mass storage device, wherein each of these devices are connected across a data bus.

A processing device can include any custom made or commercially available processor, a central processing unit (CPU) or an auxiliary processor among several processors associated with the computer system, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

Input/output interfaces provide any number of interfaces for the input and output of data. For example, where the computer system 100 comprises a personal computer, these components may interface with a keyboard or a mouse or other user input device, and for the digital player, the I/O interfaces include the remote control and the IR detector and display device such as a T.V. Where the computer system 100 comprises a handheld device (e.g., PDA, mobile telephone), these components may interface with function keys or buttons, a touch sensitive screen, a stylist, etc. Display 102 can comprise a computer monitor or a plasma screen for a PC or a liquid crystal display (LCD) on a hand held device, for example.

Referring to FIG. 4, the memory 316 includes a native operating system module 402 and an application specific module 404. The application specific module 404 includes a multimedia acquisition module 406, multimedia analyzer module 408, and temporal controller module 410. The processor 314 implements the O/S 402 to, among other things, provide menu options to the user and interpret user input. In some embodiments, the memory 316 may include one or more native applications, emulation systems, or emulated applications for any of a variety of operating systems and/or emulated hardware platforms, emulated operating systems, etc. One of ordinary skill in the art will appreciate that memory 316 can, and typically will, comprise other components which have been omitted for purposes of brevity.

Multimedia acquisition module 406 includes the logic for acquiring a multimedia bitstream in a number of ways, depending on the source. For example, multimedia acquisition module 406 may coordinate the transfer of a multimedia bitstream from the video camera 206, an optical disc, a remote server, or a mass storage device 310 to the ATCS 10. Multimedia acquisition module 406 also provides the multimedia bitstream to executable modules such as multimedia analyzer module 408, and temporal controller module 410.

A multimedia bitstream may be, for example, any type of file, data stream, or digital broadcast representing any combination of audio, video, data, text, pictures, etc. For example, multimedia streams may take the format of an MPEG-1 bitstream, an MPEG-2 bitstream, an MPEG-4 bitstream, an H.264 bitstream, a 3GPP bitstream, an AVI bitstream, a WAV bitstream, a digital video (DV) bitstream, a QuickTime (QT) file, a Compact Disc Audio (CDA) bitstream, an MPEG Audio Layer III (MP3) bitstream, an MPEG Audio Layer II (MP2) bitstream Windows Media Audio (WMA) bitstream, Windows Media Video (WMV) bitstream, Advanced System Format (ASF) bitstream, or any number of other popular digital multimedia formats. The above exemplary data streams are merely examples, and it is intended that the system cover any type of multimedia bitstream in its broadest sense.

Multimedia analyzer module 408 may be used for analyzing audio and video content within a multimedia bitstream. For example, multimedia analyzer module 408 may be used for detecting scene change positions and values, detecting whether video is interlaced, detecting the level of color saturation in the source video, detecting the contrast or brightness level of the source video, detecting motion in frames of video, or detecting various other characteristics of video or audio within a multimedia bitstream such as, but not limited to, speech, or lack thereof, amount of audio volume, and types of audio (explosions, gun-shots, mechanical sounds such as engines, etc.). In one preferred embodiment, the multimedia analyzer module 408 may not actually modify video and/or audio content, but yet in other embodiments, the multimedia analyzer module 408 may modify video and/or audio content.

The temporal controller module 410 includes the logic for categorizing segments of video content, for heirarchizing the categories of segments, and for determining variable playback rates. The temporal controller module 410 includes a conversion module 412, and a temporal compression module 414, and settings 416. The settings 416 include both default and user defined preferences/settings. An example of a preference includes a maximum playback scaling factor (α_{MAX}), where alpha is used to multiply the natural play rate ν₀. Typically, the default value for alpha is less than 2, but the user may provide his or her own value. Another exemplary preference is number of categories (N_{C}), which is explained in detail hereinbelow. The conversion module 412 is implemented by the processor 314 to reformat content. Typically, received content is reformatted so that it can be physically compressed when stored in the storage device 310.

The temporal compression module 414 is adapted to process multimedia digital content such that when the content is played, the actual play time approximately corresponds to a user-defined desired duration (T_{D}). Typically, the percent difference, which is defined as the difference between the actual play time and the desired duration divided by the desired duration, is approximately in the range of five percent (5%) or less. The temporal compression module 414 uses the settings 416 in temporally compressing the multimedia digital content.

In some embodiments, the application specific software 404 might also include a multimedia processing module (not shown), which includes the logic for performing a number of processing steps to a multimedia bitstream. For example, the multimedia processing module may be used to, among other things, normalize the volume of an audio bitstream, change the contrast or brightness level of a video bitstream, change the color saturation of a video bitstream, speed up or slow down the playback of the bitstream, video deinterlacing, audio virtual surround, audio voice extraction, video object removal, color correction/calibration, color temperature adjustment, watermarking, judder removal, smart cropping, smart scaling/stretching, chroma upsampling, skin tone correction, rotation, or other video processing tasks such as enhancing or blurring the video content. In one embodiment, the multimedia processing module is adapted to determine, among other things, an amount of motion in the data representing video content, the probability of a scene change in a segment of video and the corresponding location in the stream of multimedia data, whether the video is interlaced, whether the video has been previously altered, whether the video includes a video watermark, whether the video has been enhanced, whether the video has been blurred, the color saturation of the source video, the contrast level of source video, the brightness level of source video, the volume level of the source audio, whether the source audio is normalized, the level of hiss in the source audio, whether a video segment includes any face or eyes of a subject, whether there is any human voice in the audio stream, the noise level, the blocky level, the frame complexity, detect skin color, detect animation, object segmentation, viewer focus detect, and frame orientation detect. In one preferred embodiment, the multimedia processing module may change the bitstream that it is processing.

In some embodiments, multimedia acquisition module 406, multimedia analyzer module 408, and the temporal controller module 410 may be combined into a single module that performs any combination of the tasks performed by each of the modules separately. Thus, any modules or submodules described herein are not limited to existing as separate modules. In reality all modules may operate apart from one another, or could easily be combined as one module.

In some embodiments, a user may interact and control the operation of the application specific software 404 including the multimedia acquisition module 406, the multimedia analyzer module 408, and the temporal controller module 410 through the user input device 210 and a graphical user interface within the TV 202.

Each of the multimedia acquisition module 406, multimedia analyzer module 408, and temporal controller module 410, and any sub-modules, may comprise an ordered listing of executable instructions for implementing logical functions. When multimedia acquisition module 406, multimedia analyzer module 408, and temporal controller module 410, and any sub-modules are implemented in software, it should be noted that the system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Multimedia acquisition module 406, multimedia analyzer module 408, and temporal controller module 410, and any sub-modules can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any appropriate mechanism that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

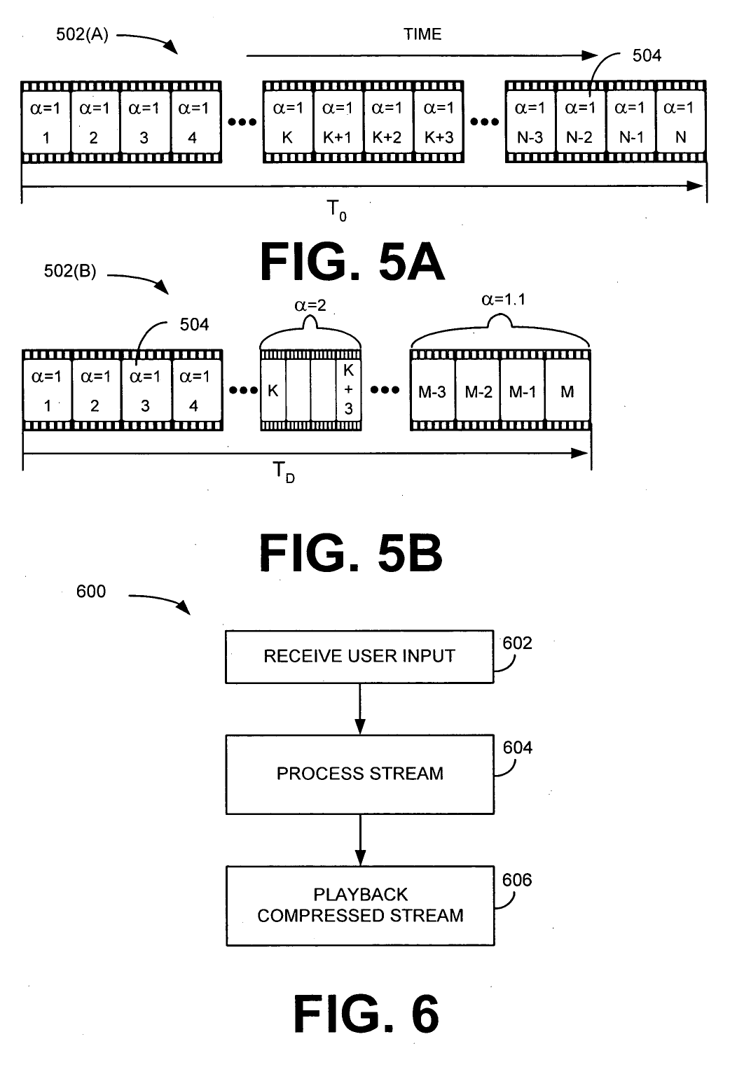

Referring to FIGS. 5A and 5B, FIG. 5A illustrates a work of multimedia content 502(A), which is made up of N frames 504, being played at its natural playback rate (ν₀). The natural playback time for the work of multimedia content 502(A) is T₀, where T₀=(N/ν₀). FIG. 5B illustrates the playback duration of a work of multimedia content 502(B), which is normally substantially identical to, or is identical to, the work of multimedia content 502(A) and which has a play time of approximately T_{D}, where T_{D} is less than T₀. The works of multimedia content 502(A) and 502(B) may or may not be identical. The play time T_{D} is less than T₀ for at least one of the following reasons:
(1) The work of multimedia digital content 502(B) is made up of M frames of information: M=N−N_{D}, where N_{D} is the number of frames dropped from the multimedia digital content 502(A). Generally, the individual frames that make-up the work of multimedia digital content 502(B) are identical to their corresponding frame in the work of multimedia digital content 502(A). For example, the first four frames of the works of multimedia digital content 502(A) and 502(B), which are numbered 1-4, are identical. The set of frames in the work of multimedia digital content 502(A) that are numbered N−3, N−2, N−1, and N are identical to the set of frames in the work of multimedia digital content 502(B) that are numbered M−3, M−2, M−1, and M.
(2) The play rate for a segment of frames is faster than the natural play rate ν₀. For example, the play rate ν of the segment of the frames that are numbered K, K+1, K+2, and K+3 in the work of multimedia digital content 502(B) is twice the natural play rate ν₀, i.e., ν=α ν₀, where α=2. (The frames that are numbered K, K+1, K+2, and K+3 in the work of multimedia digital content 502(B) are identical to the same numbered frames in the work of multimedia digital content 502(A).

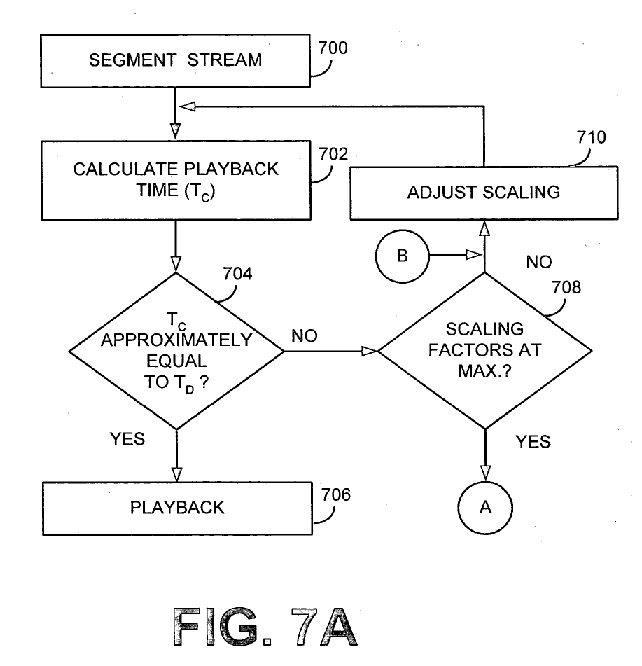

The work of multimedia digital content 502(B) is produced by the processor 314 implementing the application specific software 404 on the work of multimedia digital content 502(A). The application specific software 404 includes the logic necessary for implementing steps 600 illustrated in FIG. 6, which are exemplary steps for automatically temporally compressing video content.

In step 602, the user provides user input such as, but not limited to, selecting video content for temporal compression and the desired playing duration (T_{D}) for the selected multimedia content. In some alternative embodiments, the user can also input user preferences, which may be stored with and/or used with the settings 416. User preferences include, but are not limited to, the number of categories (N_{C}), maximum scaling factor (α_{MAX}), and other parameters. The multimedia content selected by the user can be content that is currently stored in the storage device 310 or it can be content that is currently being received by the ATCS 10.

In step 604, the selected multimedia content is processed by temporally compressing it such that its playtime approximately equals the user provided desired play duration (T_{D}).

In step 606, the temporally compressed multimedia is played to the user. The actual playback duration of the temporally compressed video is approximately equal to the desired playback duration (T_{D}).

In one embodiment, in step 602, the user provides a desired average playback rate, \overline{ν}_{D}, instead of providing a desired playback duration (T_{D}). In this embodiment, in step 606, the actual average playback rate, \overline{ν}_{A}, of the temporally compressed video is approximately equal to the desired average playback rate, \overline{ν}_{D}.

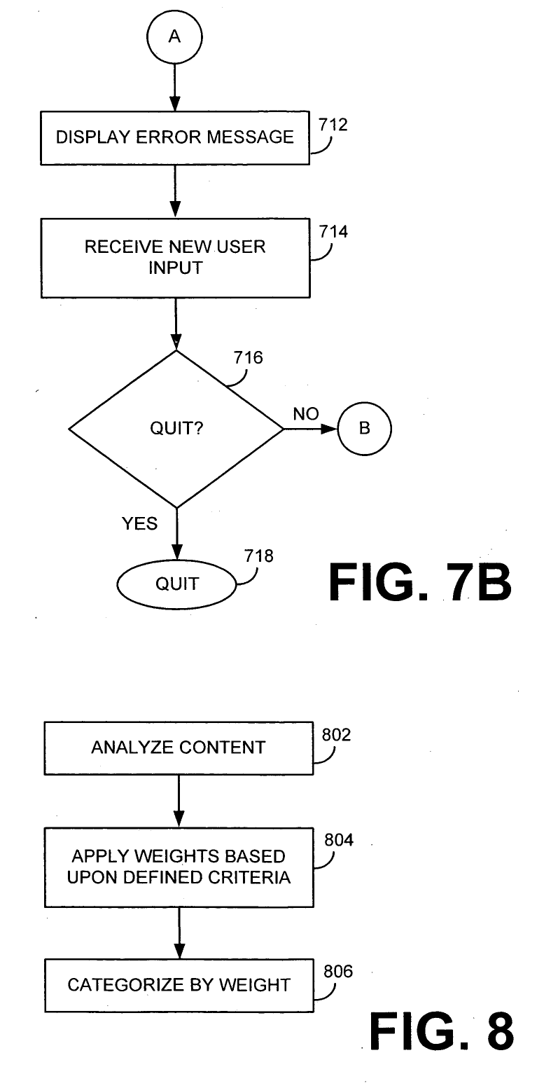

FIGS. 7A and 7B illustrate exemplary steps that are taken while performing step 604. In step 700, segments of the digital multimedia content are categorized. Generally, the number of categories (N_{C}) is set to a default value, but, in some embodiments, N_{C} is a user-defined value. For the sake of clarity, an example in which N_{C}=3 is provided, but this is a non-limiting example and it should be remembered that the default and/or user defined value for N_{C} can be different from 3. In one embodiment, the categories are hierarchized based upon some classifications. For example, a first category of segments is classified as high value, a second category of segments is classified as middle value, and a third category of segments is classified as low value. Typically, the amount of compression that is applied to each category depends upon its classification, with lower valued classifications getting more temporal compression than higher valued classifications.

In step 702, the aggregate playback time for the video is calculated. In some embodiments, each category of video is associated with a default playback scaling factor (α). For example, in some embodiments, the highest classification of segments have an initial default playback scaling factor α=1 so that the playback rate is the natural playback rate (ν₀) and the lowest classification of segments have an initialed default playback scaling factor of 1.5, i.e., the playback rate for segments in the lowest classification is 1.5ν₀. The default playback scaling factors for other categories between the lowest and highest categories are interpolated. In some embodiments, the playback scaling factors for some of the different categories are a function of the desired playback duration (T_{D}) and the initial (uncompressed) duration of the video (T₀). For example, for the case of N_{C}=3, the initial scaling factors might be α₁=1.0, α₂=1.25 (T_{D}/T₀) and α₃=1.5(T_{D}/T₀) for the highest classification of segments, middle classification of segments, and lowest classification of segments, respectively. The calculated playback time (T_{C}) is given by the equation

$${T}_{C} = {\sum }_{i = 1}^{{N}_{C}} {N}_{i} / {α}_{i} {v}_{0} ,$$

where Nᵢ is the number of frames in the i^{th} category, and αₗ is the playback scaling factor for the i^{th} category.

In step 704, a comparison is made between the calculated and desired playback time. Generally, there is a tolerance (ε) associated with the desired playback duration (T_{D}) and so long as the calculated playback duration T_{C} is within range of T_{D}−ε to T_{D}+ε, then it is approximately equal to T_{D}. In that case, in step 706, the video content is played back. However, if the value of T_{C} is not approximately equal to T_{D}, then in step 708 the playback scaling factors are checked to see if all of the scaling factors are equal to predetermined maximum values. In some embodiments, different classifications of multimedia content have different maximum scaling factors associated with them. For example, the maximum playback scaling factor (α_{MAX}) associated with the highest classification might be 1.1, and α_{MAX} for the lowest classification might be 2.

If the playback scaling factors are not maximized, then in step 710, the scaling factors for the categories are adjusted. In one preferred embodiment, the temporal compression module 414 includes logic for selectively adjusting the playback scaling factors for the different classifications of categories. Preferably, the playback scaling factors are adjusted so that most or all of the temporal compression is done in the lower valued classifications of categories. However, when necessary, the higher valued classifications of categories can be temporally compressed by raising their playback scaling factors to be greater than 1.0.

After adjusting one or more of the playback scaling factors, steps 702 and 704 are repeated, and if necessary, step 708 is repeated. If the condition of step 708 is met, i.e., the condition is “yes,” then the process continues at step 712. (See FIG. 7B.) Otherwise, the process continues until the condition of step 704 is met, at which point, the video content is replayed in step 706.

Referring to FIG. 7B, in step 712 an error message is displayed to the user. This step is reached when the temporal compression system cannot compress the user-selected video content down to the desired display duration (T_{D}). The error message may include a menu for inputting new user parameters such as increasing the desired display duration (T_{D}) and/or providing one or more new maximum playback scaling factors and/or quitting.

In step 714, the temporal compression system receives the user input, and in step 716, the automated temporal compression system interprets the user input to determine whether to quit. If the user selected “quit,” then in step 718, the automated temporal compression system quits. Otherwise, the automated temporal compression system returns to step 710. (See FIG. 7A.)

FIG. 8 is a flow chart of exemplary steps that can be implemented as part of step 700. The segmentizing of step 700 is done by analyzing the content in the multimedia content based upon given criteria. In step 802, the multimedia analyzer module 408 processes the mulitimedia content to detect, among other things, commercials, scene changes, slowly moving scene changes, trailers and/or previews, credits, opening and/or closing, etc. The multimedia analyzer module 408 may use various criteria such as, but not limited to, audio characteristics including whether the audio changes states between stereo and mono, magnitude of motion vectors, level of color saturation in the source video, contrast or brightness level of the source video, and other characteristics of the video and audio within the multimedia content. When the multimedia content that is being analyzed is in an MPEG format, the multimedia analyzer module 408 may also characterize the frames based upon, among other things, whether the frames are I, P, or B frames, which are well known to those skilled in the art, and other criteria may also be used, as well as various combinations of criteria.

In step 804, segmentation weights are associated with the frames 504 of multimedia content. For example, when the audio for a given frame switches from mono to stereo, the change of audio characteristic might signify the beginning of a commercial, and consequently, that given frame will receive a large segmentation weight. In addition, audio characteristics such as the presence or lack of speech, gun shots, explosions, and mechanical noises can be used to associate segmentation weights. Similarly, a frame that has little motion i.e., a frame with small motion vectors, will receive a higher segmentation weight than a frame with a lot of motion, i.e., a frame with large motion vectors. Relative quantities such as large or small motion vectors can be determined according to the magnitude of the motion vector divided by the magnitude of a reference vector. So, for example, if the magnitude of a given motion vector is twice the magnitude of the reference vector, then the given vector is a large motion vector. But, on the other hand, if the magnitude of the given vector is one-half that of the reference vector, then the given vector is a small vector. Generally, a predicted frame includes more than one motion vector and consequently, the temporal compression module 414 includes logic for calculating a representative motion vector based upon a statistical method. For example, the representative motion vector could be a mean, median, or mode magnitude of the motion vectors in the given frame or the largest magnitude, or the smallest magnitude.

In step 806, the segmentation weights are used to categorize and hierarchize the frames of multimedia content. For example, all of the frames that have a segmentation weight beneath a predetermined lower threshold are categorized with the highest classification; all of the frames that have a segmentation weight above a predetermined upper threshold are categorized with the lowest classification; and all of the frames that have a segmentation weight between the lower and upper thresholds are categorized with the middle classification. In an alternative embodiment, the frames can be categorized and heirarchized based upon a statistical distribution of segmentation weights. For example, the frames that are included in the category having the highest classification account for 25% of the total number of frames; the frames that are included in the category having the lowest classification account for 25% of the total number of frames; and the frames that are included in the category having the middle classification account for 50% of the total number of frames.

As previously mentioned hereinabove, in some embodiments, the user provides a desired average playback rate, \overline{ν}_{D}. Those skilled in the art would recognize how the exemplary method described hereinabove could be modified such that the actual average playback rate, \overline{ν}_{A}, is approximately equal to the desired average playback rate, \overline{ν}_{D}. For example, in step 702, the different categories of segments are provided an initial playback rate (αν₀), and the average playback rate is then calculated. The calculated average playback rate, \overline{ν}_{C}, is given by

$${\overline{v}}_{C} = {\sum }_{i = 1}^{{N}_{C}} {N}_{i} {α}_{i} {v}_{0} ,$$

where Nᵢ is the number of frames in the i^{th} category, and αₗ, is the playback scaling factor for the i^{th} category, and, in step 704, the comparison would be between the calculated average playback rate, \overline{ν}_{C}, and the desired average playback rate, \overline{ν}_{D}. Furthermore, if the calculated average playback rate, \overline{ν}_{C}, is not approximately equal to the desired average playback rate, \overline{ν}_{D}, then steps 708-718 are implemented as needed. In addition, in this embodiment, steps 802-806 may also be implemented.

In one preferred embodiment, when frames are identified as being commercials, those frames are automatically dropped, i.e., they are not played back to the user. However, in some alternative embodiments, frames that contain commercials are initially included in the category of segments that has the lowest classification, but the commercial frames are then dropped as needed to make the desired playback duration (T_{D}) approximately equal the actual playback duration. In some embodiments, frames that contain trailers and/or previews, and credits, opening and/or closing, are also included in the category of segments that has the lowest classification, and frames from that category can be dropped as needed. In addition, in some embodiments, frames that do not include commercials can also be dropped as needed, even frames that are not included in the category having the lowest classification.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. For example, embodiments have been described in which the user inputs ratings using devices such as a PC keyboard/mouse and a remote control. However, in another non-limiting embodiment, the user provides user input using an input device such as a thumbwheel to allow rapid up/down input. This type of input device can be used, with or without visual feedback, to provide Ratings of content by the user. All such modifications and variations are intended to be included herein within the scope of this disclosure and the present invention and protected by the following claims.

Therefore, having thus described the invention, at least the following is claimed:

1. A method of providing a work of multimedia content, the method comprising the steps of:
receiving user input, wherein the user input is included in a group comprising desired playback duration (T_{D}) and desired average playback rate (\overline{ν}_{D});
categorizing segments the multimedia content based at least in part upon information carried by the multimedia content; and
using the user input to determine playback rates for the segments of the multimedia content.

2. The method of claim 1, wherein the user input is desired playback duration (T_{D}), and wherein responsive to each segment being provided at its playback rate, the aggregate actual playback duration of the work of multimedia content is approximately equal to the desired playback duration.

3. The method of claim 1, wherein a first category of segments are played at a first playback rate, and a second category of segments are played at a second playback rate, the first playback rate being different than the second playback rate.

4. The method of claim 1, wherein the user input is desired playback duration (T_{D}), and further including the step of:
determining the natural playback duration (T₀) of the work of multimedia content, wherein the natural playback duration is defined as the time span for playing the work at the natural playback rate (ν₀) of the work, and wherein the natural playback duration (T₀) and the desired playback duration (T_{D}) are used in the step of using the user input to determine playback rates of the categorized segments.

5. The method of claim 1, further including the steps of:
heirarchizing the categorized segements from a first classification to a last classification;
associating a first playback rate (ν₁) with the first classification of segments and a second playback rate (ν₂) with the last classification of segments, wherein the second playback rate (ν₂) is faster than the first playback rate (ν₁).

6. The method of claim 5, further including the step of:
associating a third playback rate (ν₃) with a third classification of segments, the third classification interposing the first and last hierarchized classifications and the third playback rate (ν₃) being less than the second playback rate (ν₂).

7. The method of claim 6, wherein the third playback rate (ν₃) is greater than the first playback rate (ν₁).

8. The method of claim 1, wherein the user input is desired playback duration (T_{D}), and further including the steps of:
(a) hierarchizing the categorized segments from a first classification to a last classification;
(b) determining a playback rate for each classification of categorized segment;
(c) determining the playback duration for each classification of categorized segments;
(d) aggregating the playback duration for each classification of categorized segments; and
(e) determining whether the aggregated playback duration is within a predetermined range of the desired playback time.

9. The method of claim 8, wherein responsive to determining the aggregate playback time is not within the predetermined range of the desired playback time, further including the steps of:
(f) determining at least one new playback rate for at least one classification of the categorized segments;
(g) determining the playback time for each classification of categorized segments having a new playback rate; and
(h) repeating steps (d)-(g) until the aggregate playback duration is within the predetermined range of the desired playback duration.

10. An apparatus for providing multimedia content, the apparatus comprising:
a memory have a temporal compression module stored therein;
a processor in communication with the memory, the processor adapted to receive a user input for a given work of multimedia content, responsive to receiving the user input, the processor implements the temporal compression to provide the given work of multimedia content at a plurality of playback rates, wherein the user input is included in a group comprising desired playback duration (T_{D}) and desired average playback rate (\overline{ν}_{D}).

11. The apparatus of claim 10, wherein the user input is desired average playback rate (\overline{ν}_{D}).

12. The apparatus of claim 10, wherein the apparatus is a computer.

13. The apparatus of claim 10, wherein the given work of multimedia content includes frames of information, and wherein the memory further includes an analyzing module for analyzing content within the frames.

14. The apparatus of claim 13, wherein the user input is desired playback duration (T_{D}), and wherein the temporal compression module determines whether frames of the given work should not be provided, wherein by not providing frames of the given work, the actual playback duration of the given work approximately matches desired playback duration.

15. The apparatus of claim 14, wherein the frames that are not provided include frames of commercials.

16. The apparatus of claim 14, wherein the frames that are not provided includes at least one frame selected from a set of frames consisting of frames of trailers, frames of titles, and frames of credits.

17. The apparatus of claim 13, wherein the given work of multimedia content includes video content, wherein the temporal compression module compresses frames based upon the amount of motion depicted within the frames.

18. The apparatus of claim 17, wherein the temporal compression module determines the amount of motion depicted within a given frames based at least in part upon motion vectors associated with the frame.

19. The apparatus of claim 17, wherein the given work of multimedia content includes audio content, wherein the temporal compression module compresses frames based upon the audio content.

20. A program embodied in a computer readable medium, the program comprising:
logic configured to receive a user input, wherein the user input is included in a group comprising desired playback duration (T_{D}) and desired average playback rate (\overline{ν}_{D});
logic configured to categorize segments the multimedia content based at least in part upon information carried by the multimedia content; and
logic configured to use the user input to determine playback rates for the segments of the multimedia content.

21. The program of claim 20, wherein the user input is desired playback duration, and wherein responsive to each segment being provided at its playback rate, the aggregate actual playback duration of the work of multimedia content is approximately equal to the desired playback duration.

22. The program of claim 20, wherein the user input is desired playback duration, and further including:
logic configured to determine the natural playback duration (T₀) of the work of multimedia content, wherein the natural playback duration is defined as the time span for playing the work at the natural playback rate (ν₀) of the work, and wherein the natural playback duration (T₀) and the desired playback duration (T_{D}) are used in the step of determining the playback rates of the categorized segments.

23. The program of claim 20, further including:
logic configured to heirarchize the categorized segements from a first classification to a last classification;
logic configured to associate a first playback rate (ν₁) with the first classification of segments and a second playback rate (ν₂) with the last classification of segments, wherein the second playback rate (ν₂) is faster than the first playback rate (ν₁).

24. The program of claim 23, further including:
logic configured to associate a third playback rate (ν₃) with a third classification of segments, the third classification interposing the first and last hierarchized classifications and the third playback rate (ν₃) being less than the second playback rate (ν₂).

25. The program of claim 24, wherein the third playback rate (ν₃) is greater than the first playback rate (ν₁).

26. The program of claim 20, wherein the user input is desired playback duration, and further including:
(a) logic configured to hierarchize the categorized segments from a first classification to a last classification;
(b) logic configured to determine a playback rate for each classification of categorized segment;
(c) logic configured to determine the playback duration for each classification of categorized segments;
(d) logic configured to aggregate the playback duration for each classification of categorized segments; and
(e) logic configured to determine whether the aggregated playback duration is within a predetermined range of the desired playback time.

27. The method of claim 26, further including:
(f) logic configured to determine at least one new playback rate for at least one classification of the categorized segments;
(g) logic configured to determine the playback time for each classification of categorized segments having a new playback rate; and
(h) logic configured to determine whether to repeat logic (d)-(g) until the aggregate playback duration is within the predetermined range of the desired playback duration, wherein responsive to determining the aggregate playback time is not within the predetermined range of the desired playback time the logic of (d)-(g) is repeated.
